(19) United States
(12) Patent Application Publication
(10) Pub. No.: US 2020/0182502 A1
(43) Pub. Date: Jun. 11, 2020

(54) NETWORK SYSTEM

(71) Applicant: SHARP KABUSHIKI KAISHA, Sakai City, Osaka (JP)

(72) Inventors: SHOTA INOUE, Sakai City, Osaka (JP); TAKUMA MIZUNO, Sakai City, Osaka (JP)

(21) Appl. No.: 16/629,420

(22) PCT Filed: Jan. 11, 2018
(86) PCT No.: PCT/JP2018/000421

§ 371 Date: Jan. 8, 2020

(30) Foreign Application Priority Data
Sep. 29, 2017 (JP) 2017-191682

(51) Int. Cl. F24F 11/58; H04L 29/08; G05B 15/02

(52) U.S. Cl. CPC F24F 11/58; G05B 15/02; H04L 67/12

(57) ABSTRACT

Provided herein is a network system (1) that includes a first air conditioning device (100, 200), a second air conditioning device (200, 100), and a server 300 that controls the second air conditioning device (200, 100) in accordance with information from the first air conditioning device (100, 200).

### TECHNICAL FIELD

The present invention relates to an air conditioning device technology, particularly a technology for information communication between multiple air conditioning devices.

### BACKGROUND ART

A technology for automatically cleaning the interior of an air conditioning device is known. For example, JP-A-2016-114270 (PTL1) discloses an air conditioning device, an air conditioning device control method, and a program. PTL 1 provides an air conditioning device that includes an image capturing unit for sensing room interior with infrared light and/or visible light, and a control unit for controlling air conditioning of the room interior using at least data acquired by the image capturing unit. The air conditioning device has an information input-output section that communicates with a monitoring system having an image capturing unit for sensing room interior with infrared light and/or visible light, and the control unit enables control by associating with the monitoring system, using input and output information to and from the monitoring system via the information input-output section.

JP-A-2014-70883 (PTL 2) discloses an air conditioning device and an air conditioning system. PTL 2 describes an air conditioning device that controls an air conditioning appliance installed in a room, in a coordinated fashion with air conditioning operations. The air conditioning device includes a detection unit for detecting a room environment index, and a control unit for controlling an air conditioning operation and a humidifier operation. The control unit recognizes the location of the humidifier in a room and acquires an index from the humidifier, and, when there is a large difference between the acquired index and an index detected by the detection unit, controls the air conditioning operation so as to direct wind toward the humidifier.

### CITATION LIST

### Patent Literature

PTL 1: JP-A-2016-114270

PTL 2: JP-A-2014-70883

### SUMMARY OF INVENTION

### Technical Problem

An object of the present invention is to provide a network system that enables efficient exchange of information between multiple air conditioning devices.

### Solution to Problem

According to a certain aspect of the present invention, there is provided a network system that includes a first air conditioning device, a second air conditioning device, and a server that controls the second air conditioning device in accordance with information from the first air conditioning device.

### Advantageous Effects of Invention

The present invention has therefore provided a network system that enables efficient exchange of information between multiple air conditioning devices.

### BRIEF DESCRIPTION OF DRAWINGS

FIG. 1 is a schematic diagram representing an overall configuration of a network system 1 according to First Embodiment.

FIG. 2 is a block diagram representing a configuration of an air conditioner 100 according to First Embodiment.

FIG. 3 is a block diagram representing a configuration of an air purifier 200 according to First Embodiment.

FIG. 4 is a block diagram representing a configuration of a server 300 according to First Embodiment.

FIG. 5 is a schematic diagram representing device data 321 according to First Embodiment.

FIG. 6 is a schematic diagram representing associated operation data 322 according to First Embodiment.

FIG. 7 is a schematic diagram representing sleep association data 323 according to First Embodiment.

FIG. 8 is a schematic diagram representing associated pair data 324 according to First Embodiment.

FIG. 9 is a flowchart representing an information process of the server 300 according to First Embodiment.

FIG. 10 is a block diagram representing a configuration of a communication terminal, such as a smartphone 400, according to First Embodiment.

FIG. 11 is a schematic diagram representing an example of a screen of a smartphone 400 according to First Embodiment.

FIG. 12 is a schematic diagram representing an example of a screen of a smartphone 400 according to Second Embodiment.

FIG. 13 is a schematic diagram representing an overall configuration of a network system 1 according to Second Embodiment.

FIG. 14 is a schematic diagram representing an example of a screen of a smartphone 400 according to Third Embodiment.

FIG. 15 is a schematic diagram representing an overall configuration of a network system 1 according to Third Embodiment.

### DESCRIPTION OF EMBODIMENTS

Embodiments of the present invention are described below with reference to the accompanying drawings. In the following descriptions, like elements are given like reference numerals. Such like elements will be referred to by the same names, and have the same functions. Accordingly, detailed descriptions of such elements will not be repeated.

### First Embodiment

### Overall Configuration of Network System 1

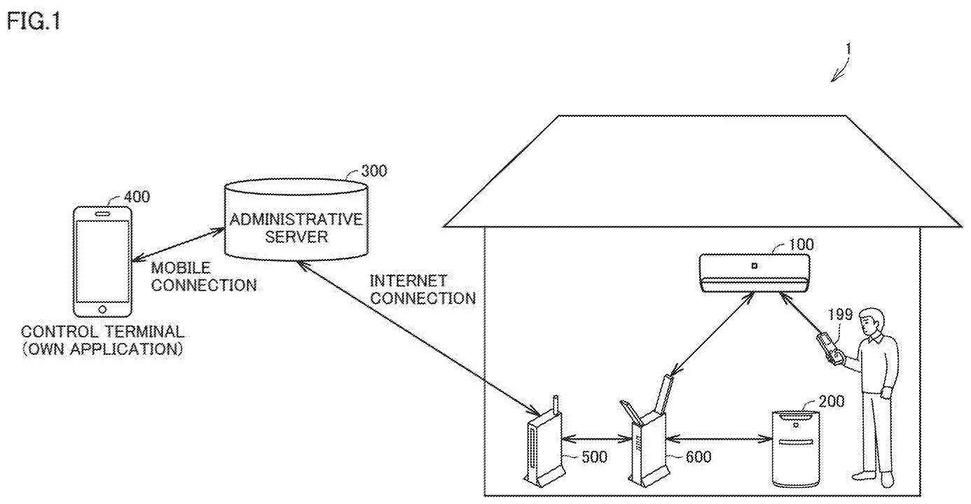

An overall configuration of a network system 1 according to the present embodiment is described below, with reference to FIG. 1. The main components of the network system 1 according to the present embodiment include a server 300 for home appliance control applications, a communication terminal, such as a smartphone 400, used to exchange various data with the server 300, and an air conditioning device, such as an air conditioner 100 or an air purifier 200, used to exchange various data with the server 300 via a modem 500 and a WiFi® router 600.

The air conditioning device may be, for example, an air conditioner 100 having cooling and heating functions, an air purifier 200 having an air purifying function, a humidifier having a humidifying function, or a fan. The communication terminal is not limited to the smartphone 400, and may be other communication terminal, for example, such as a tablet, a gaming machine, a wearable terminal, or a personal computer.

### Overall Operation of Network System 1

In the network system according to the present embodiment, information acquired by a sensor of the air purifier 200 is presented to the air conditioner 100 to enable the air conditioner 100 to operate by using the information, or, conversely, information acquired by a sensor of the air conditioner 100 is presented to the air purifier 200 to enable the air purifier 200 to operate by using the information. The following describes the network system 1 with regard to specific configurations that enable these functions.

### Configuration of Air Conditioner 100

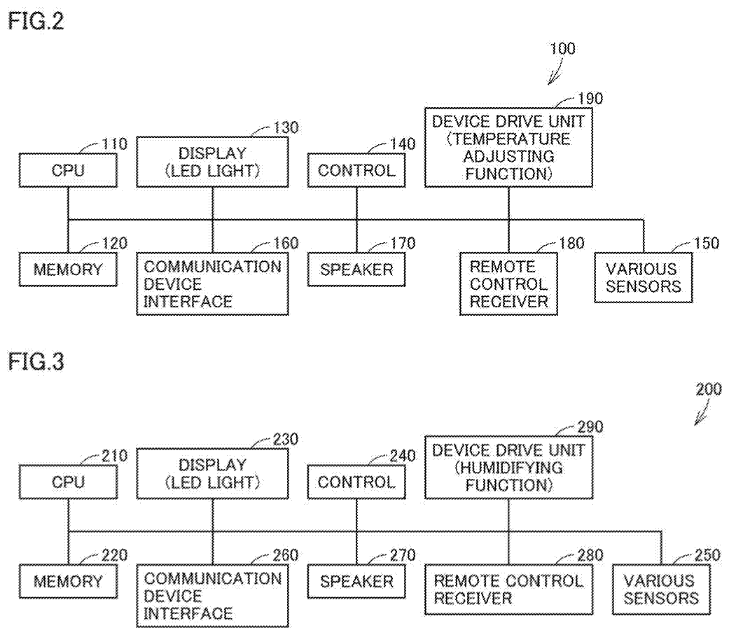

An exemplary configuration of the air conditioner 100 constituting the network system 1 is described below, with reference to FIG. 2. The main components of the air conditioner 100 according to the present embodiment include a CPU 110, a memory 120, a display 130, a control 140, various sensors 150, a communication interface 160, a speaker 170, a remote control photoreceiver 180, and a device drive unit 190.

The CPU 110 controls different parts of the air conditioner 100 by executing the programs stored in the memory 120 or in an external storage medium.

The memory 120 is implemented as various types of RAMs and ROMs, for example. The memory 120 stores, for example, programs to be executed by the CPU 110, data generated by execution of a program by the CPU 110, input data via the control 140, received data from a remote controller, and data received from the server 300 via the router and the Internet.

The display 130 outputs, for example, characters and images using signals from the CPU 110. The display 130 may be simply a light.

The control 140 is implemented as buttons, for example. The control 140 receives an instruction from a user, and inputs the instruction to the CPU 110. The display 130 and the control 140 may constitute a touch panel.

The various sensors 150 are temperature sensors and humidity sensors, and input measured temperatures and humidities to the CPU 110.

The communication interface 160 is provided for data exchange with other devices via wired or wireless communication Specifically, the communication interface 160 receives data from the CPU 110, and sends the received data to the server 300 and other devices. Conversely, the communication interface 160 is controlled to receive various data from other devices, and input the received data to the CPU 110.

The speaker 170 outputs various voices, sounds, and melodies, using signals from the CPU 110.

The remote control photoreceiver 180 detects an infrared signal from, for example, a remote controller, and inputs the received signal to the CPU 110. For example, the CPU 110 receives a power ON/OFF instruction, and various other control instructions and various types of data from the remote controller via the remote control photoreceiver 180.

The device drive unit 190 controls different parts of the electronic device, for example, such as a compressor, a fan, motors, and a heater, using signals from the CPU 110. With the device drive unit 190, the air conditioner 100 according to the present embodiment can provide various functions, including, for example, cooler, heater, fan, and ion generating functions.

With the foregoing configuration, the CPU 110 exchanges information (e.g., connection ID) with the smartphone 400 via the communication interface 160, and uses the information to establish a pairing with the smartphone 400, via the server 300. The CPU 110, via the communication interface 160, provides the paired smartphone 400 with information that a heating operation, a cooling operation, or a fan operation will be performed, or information such as set temperature, set humidity, current temperature, and current humidity, via the server 300. The CPU 110 also receives a remote control instruction from, for example, the smartphone 400, via the server 300.

From the server 300, the CPU 110 is able to acquire values acquired by a sensor of the air purifier 200, via the communication interface 160. By using an instruction acquired from the server 300, the CPU 110 performs a heating, cooling, or fan operation, or sets temperature and humidity. For example, upon the air purifier 200 detecting that the room illuminance has decreased, the air conditioner 100 starts operating in sleep mode, using data from the server 300. Conversely, the CPU 110, with the communication interface 160, provides the air purifier 200 with an operation status and data from various sensors, via the server 300.

### Configuration of Air Purifier 200

An exemplary configuration of the air purifier 200 constituting the network system 1 is described below, with reference to FIG. 3. The main components of the air purifier 200 according to the present embodiment include a CPU 210, a memory 220, a display 230, a control 240, various sensors 250, a communication interface 260, a speaker 270, a remote control photoreceiver 280, and a device drive unit 290.

The configurations of these components are the same as those of the air conditioner 100, and will not be described again. Of note, however, is that the air purifier 200 according to the present embodiment offers various functions, including, for example, air purification, humidification, and ion generating functions, with the device drive unit 290. The various sensors 250 are provided to measure, for example, amounts of dust, the extent of odor, and illuminance, and input the measured results to the CPU 210.

As with the case of the CPU 110, the CPU 210 of the air purifier 200 exchanges information (e.g., connection ID) with the smartphone 400 via the communication interface 260, and establishes a pairing with the smartphone 400 via the server 300, using the information. The CPU 210, via the communication interface 260, provides the paired smartphone 400 with information that various operations will be performed, or information such as set humidity and current humidity, via the server 300. The CPU 210 also receives a remote control instruction from, for example, the smartphone 400, via the server 300.

The CPU 210, via the communication interface 260, sends the server 300 the amount of dust, the extent of odor, and the illuminance acquired by the various sensors 250. Conversely, the CPU 210, via the communication interface 260, receives from the server 300, for example, information that the air conditioner 100 has started a heating operation, and starts a humidifying operation in response.

### Configuration of Server 300

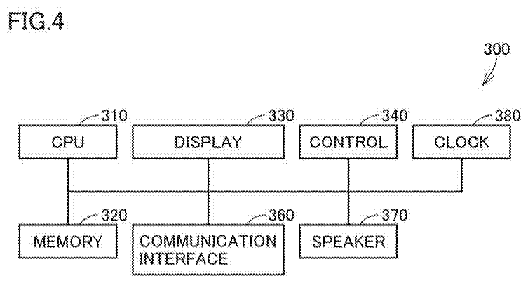

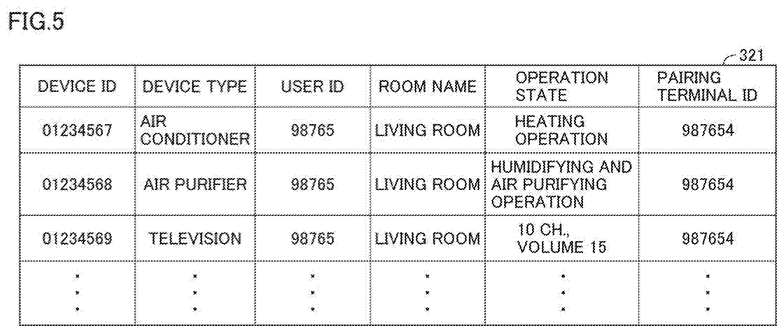

An exemplary configuration of the server 300 constituting the network system 1 is described below, with reference to FIG. 4. The main components of the server 300 according to the present embodiment include a CPU 310, a memory 320, a display 330, a control 340, and a communication interface 360.

The CPU 310 controls different parts of the server 300 by executing the programs stored in the memory 320. For example, the CPU 310 executes the programs stored in the memory 320, and performs various processes (described later) by referring to various data.

The memory 320 is implemented as various types of RAMs and ROMs, for example. The memory 320 may be included in the server 300, or may be detachably provided for various interfaces of the server 300, or may be a storage medium of a device that is accessible from the server 300. The memory 320 stores, for example, programs to be executed by the CPU 310, data generated by execution of a program by the CPU 310, input data, device data 321, associated operation data 322, sleep association data 323, associated pair data 324, and database used for home appliance control services according to the present embodiment.

As shown in FIG. 5, the device data 321 includes various types of information on a per-device (e.g., air conditioner 100, air purifier 200) basis, including, for example, device identification information, device type, user identification information, names specifying rooms, operation states such as an operation instruction specifying the current device operation, and various measurement results acquired by sensors, and identification information of the paired smartphone 400 or a user. In response to a request from an application (app) of a communication terminal such as the smartphone 400, the CPU 310 refers to the device data 321, and provides information about the device installed in a designated room, from among the devices paired with the smartphone 400.

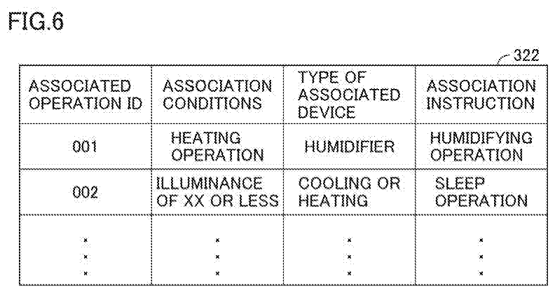

As shown in FIG. 6, the associated operation data 322 includes various types of information, including, for example, associated operation ID, associated operation conditions, type of associated device, and instructions to be issued when conditions are met. These are stored for each type of associated device operation.

As shown in FIG. 1, the sleep association data 323 stores ON/OFF of sleep operation regarding where the input of sleep operation instruction is made (i.e., the current state), and the type of new sleep operation instruction.

As shown in FIG. 8, the associated pair data 324 includes associated pair ID, and identification information of a plurality of associated devices, on a per-associated operation pair basis. In response to a request from an app of a communication terminal such as the smartphone 400, the CPU 310 registers in the associated pair data 324 combinations of devices to be associated, from among the devices already paired with the smartphone 400.

Referring back to FIG. 4, the display 330 displays texts and images, using signals from the CPU 310. The control 340 receives an instruction from, for example, a service administrator, and inputs the instruction to the CPU 310.

The communication interface 360 sends data from the CPU 310 to other devices, such as the air conditioner 100 and the smartphone 400, via, for example, the Internet, a carrier network, and a router. Conversely, the communication interface 360 receives data from other devices via, for example, the Internet, a carrier network, and a router, and transfers the received data to the CPU 310.

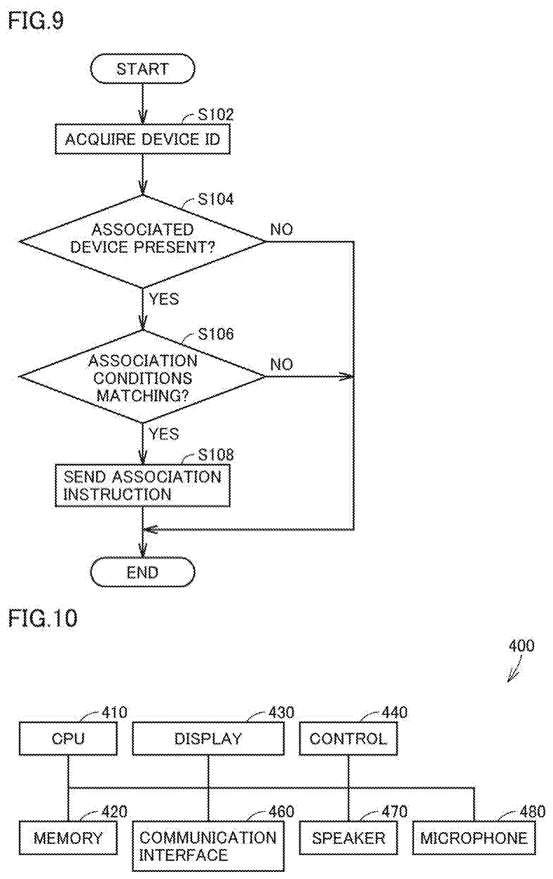

The CPU 310 of the server 300 according to the present embodiment performs the following processes upon receiving data from devices such as the air conditioner 100 and the air purifier 200 via the communication interface 360, as shown in FIG. 9.

From received data, the CPU 310 reads various types of information, including device identification information, the operation state of a device, and data measured by a sensor of a device (step S102). By referring to the associated pair data 324, the CPU 310 determines the presence or absence of an associated device (step S104). If it is determined that an associated device is present (YES in step S104), the CPU 310 reads data concerning the associated device by referring to the device data 321, and determines whether any of associated operation conditions is met, by referring to the associated operation data 322 (step S106). If any of associated operation conditions is met (YES in step S106), the CPU 310 sends an association instruction to the associated device, via the communication interface 360 (step S108). The CPU 310 then awaits data from the next device, via the communication interface 360.

For example, when the air conditioner 100 and the air purifier 200 are associated (YES in step S104), and when association conditions are met that the illuminance based on data from the illuminance sensor of the air purifier 200 is low, and that a predetermined time has elapsed (YES in step S106), the CPU 310 causes the air conditioner 100 to start a sleep operation by sending an association instruction (step S108). As another example, when the air conditioner 100 and the air purifier 200 are associated (YES in step S104), and when an association condition is met that the air conditioner 100 is running in heating mode (YES in step S106), the CPU 310 causes the air purifier 200 to start a humidifying operation by sending an association instruction (step S108).

To describe more specifically, in the present embodiment, the CPU 310 of the server 300 sends a sleep operation instruction to the air conditioner 100 via the communication interface 360 when the result of detection by the illuminance sensor of the air purifier 200 corresponding to the air conditioner 100 is “dark”, and when this condition has continued for at least 15 minutes. On the other hand, when the result of detection by the illuminance sensor of the air purifier 200 is not “dark” continuously for a time period of 15 minutes or more, the CPU 310 of the server 300 sends a sleep operation canceling instruction to the corresponding air conditioner 100 via the communication interface 360. In the event that the sleep operation is canceled in response to, for example, an instruction from the remote controller 199, the server 300 does not allow a transition to a new sleep operation to be made unless the result of detection by the illuminance sensor of the air purifier 200 becomes “not dark” again.

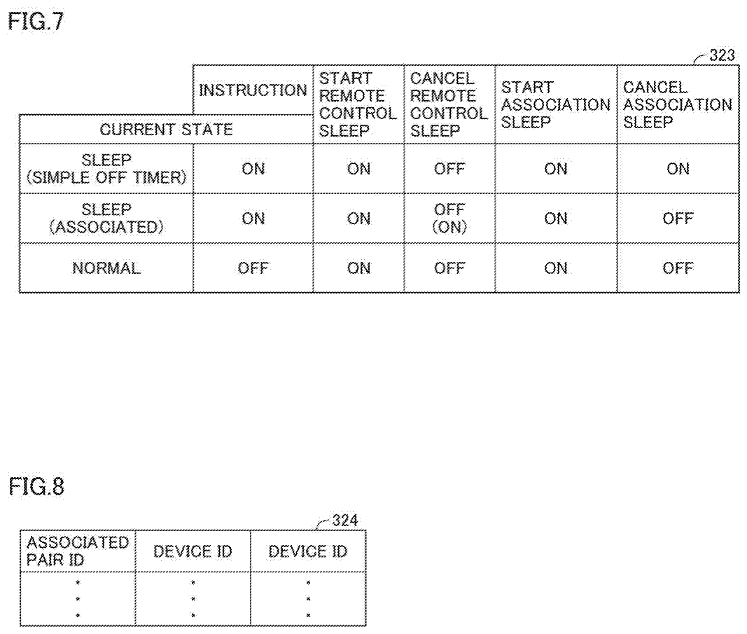

In response to input of an instruction for sleep operation attributed to association of devices while the remote controller 199 is enabling an off timer for sleep operation as shown in FIG. 7, the server 300 or the air conditioner 100 disables the sleep operation instruction. In response to input of an instruction for canceling a sleep operation attributed to association of devices while the remote controller 199 is enabling an off timer for sleep operation, the server 300 or the air conditioner 100 disables the sleep operation cancellation instruction. That is, it is preferable that the server 300 or the air conditioner 100 give a higher priority for instructions made through the remote controller than for instructions by association of devices.

More specifically, referring to the top row in FIG. 7, the air conditioner 100 keeps running in sleep mode in response to input of a sleep operation start instruction entered by the remote controller 199 during a sleep operation attributed to the remote controller 199. The air conditioner 100 stops running in sleep mode in response to input of a sleep operation cancel instruction entered by the remote controller 199 during a sleep operation attributed to the remote controller 199. The air conditioner 100 keeps running in sleep mode in response to input of a sleep operation start instruction attributed to association of devices entered during a sleep operation attributed to the remote controller 199. The air conditioner 100 also keeps running in sleep mode in response to input of a sleep operation cancel instruction attributed to association of devices entered during a sleep operation attributed to the remote controller 199.

Referring to the middle row in FIG. 7, the air conditioner 100 keeps running in sleep mode in response to input of a sleep operation start instruction entered by the remote controller 199 during a sleep operation attributed to association of devices. The air conditioner 100 stops running in sleep mode in response to input of a sleep operation cancel instruction entered by the remote controller 199 during a sleep operation attributed to association of devices. Here, the system may be adapted so that the sleep operation is not canceled. The air conditioner 100 keeps running in sleep mode in response to input of a sleep operation start instruction attributed to association of devices entered during a sleep operation attributed to association of devices. The server 300 cancels the sleep operation in the air conditioner 100 in response to input of a sleep operation cancel instruction attributed to association of devices entered during a sleep operation attributed to association of devices.

Referring to the bottom row in FIG. 7, the air conditioner 100 starts running in sleep mode in response to input of a sleep operation start instruction entered by the remote controller 199 while the air conditioner 100 is not running in sleep mode. The air conditioner 100 does not start running in sleep mode in response to input of a sleep operation cancel instruction entered by the remote controller 199 while the air conditioner 100 is not running in sleep mode. The server 300 causes the air conditioner 100 to start running in sleep mode in response to input of a sleep operation start instruction attributed to association of devices entered while the air conditioner 100 is not running in sleep mode. Evidently, the air conditioner 100 does not start running in sleep mode in response to input of a sleep operation cancel instruction attributed to association of devices entered while the air conditioner 100 is not running in sleep mode.

### Configuration of Smartphone 400

An exemplary configuration of a communication terminal, for example, the smartphone 400, according to the present embodiment is described below, with reference to FIG. 10. The main components of the smartphone 400 include a CPU 410, a memory 420, a display 430, a control 440, a communication interface 460, a speaker 470, and a microphone 480.

The CPU 410 controls different parts of the smartphone 400 by executing the programs stored in the memory 420.

The memory 420 is implemented as various types of RAMs and ROMs, for example. The memory 420 stores various types of information, including, for example, programs to be executed by the CPU 410 (for example, application programs for controlling home appliances), data generated by execution of a program by the CPU 410, input data, and database used for home appliance control services according to the present embodiment.

The display 430 displays texts and images, using signals from the CPU 410. The control 440 receives, for example, a user instruction, and inputs the instruction to the CPU 410. For example, by using an application program for controlling the air conditioner 100, the CPU 410 displays a control screen in the display 430, and accepts input of a remote control instruction for the air conditioner 100 through the control 440. The display 430 and the control 440 may constitute a touch panel.

The communication interface 460 sends data from the CPU 410 to other devices, such as the server 300, via, for example, the Internet, a carrier network, and a router. Conversely, the communication interface 460 receives data from other devices via, for example, the Internet, a carrier network, and a router, and transfers the received data to the CPU 410.

The speaker 470 outputs various voices, sounds, and melodies, using data from the CPU 410. The microphone 480 receives voice sounds, and inputs the sound data to the CPU 410.

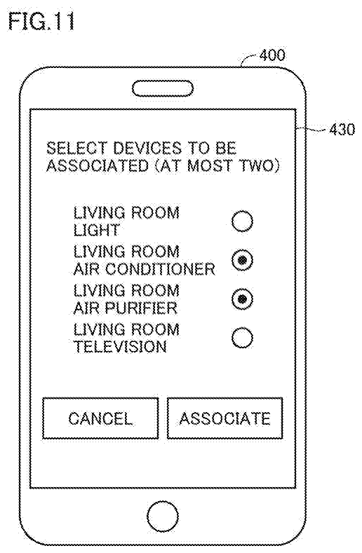

In the present embodiment, the CPU 410, upon receiving a user instruction concerning association of home appliances via the control 440, acquires information of paired devices from the server 300 via the communication interface 460, and causes the display 430 to selectably show a list of devices available for association, as shown in FIG. 11. In response to an instruction specifying a plurality of devices to be associated, the CPU 410 sends the association information to the server 300, via the communication interface 460.

More specifically, the CPU 410 performs the following processes using an application program for controlling home appliances. In response to a user entering an instruction concerning association of home appliances, and an instruction specifying a room via the control 440, the CPU 410 sends the server 300, for example, the ID of the smartphone 400, the user ID and password, and information specifying the room where association is to be made, via the communication interface 460. The CPU 310 of the server 300 sends the smartphone 400 information about devices that have been paired with the smartphone 400 and corresponding to the specified room, via the communication interface 360. In response, the CPU 410 causes the display 430 to selectably show a list of devices available for association in the room, as shown in FIG. 11. In response to an instruction specifying a plurality of devices to be associated, the CPU 410 sends the association information to the server 300 via the communication interface 460. By using the data from the smartphone 400, the CPU 310 of the server 300 registers the new association in the associated pair data 324. Once the data is registered, the air conditioner 100 and the air purifier 200 belonging to the newly registered association are able to run operations that are more appropriate from their measurement results and operation states, via the server 300.

### Second Embodiment

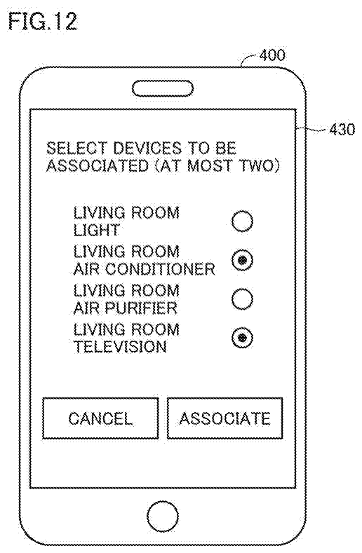

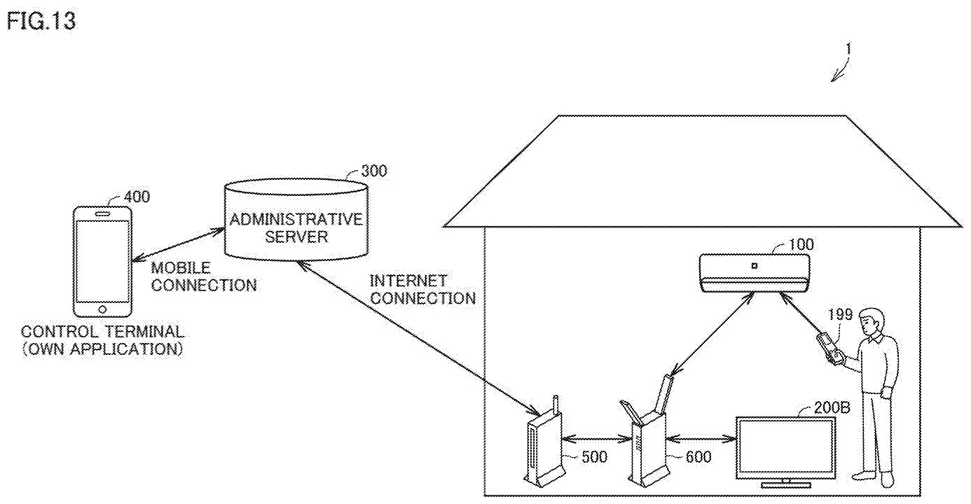

First Embodiment described an association between the air conditioner 100 and the air purifier 200. However, an association may be made between an air conditioner 100 and a television 200B, as shown in FIGS. 12 and 13. In this case, the data acquired by an illuminance sensor and a motion sensor of the television 200B become available for use by the air conditioner 100. For example, the server 300 may control and reduce the airflow of the air conditioner 100 by using information that the volume of the television 200B has been turned down.

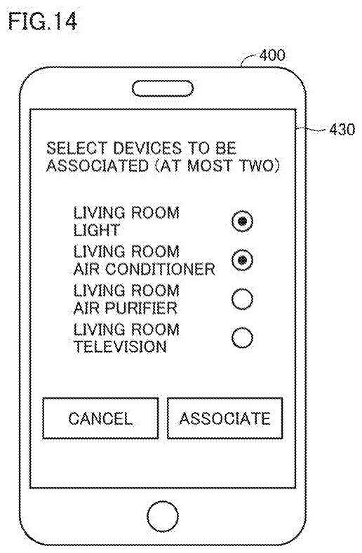

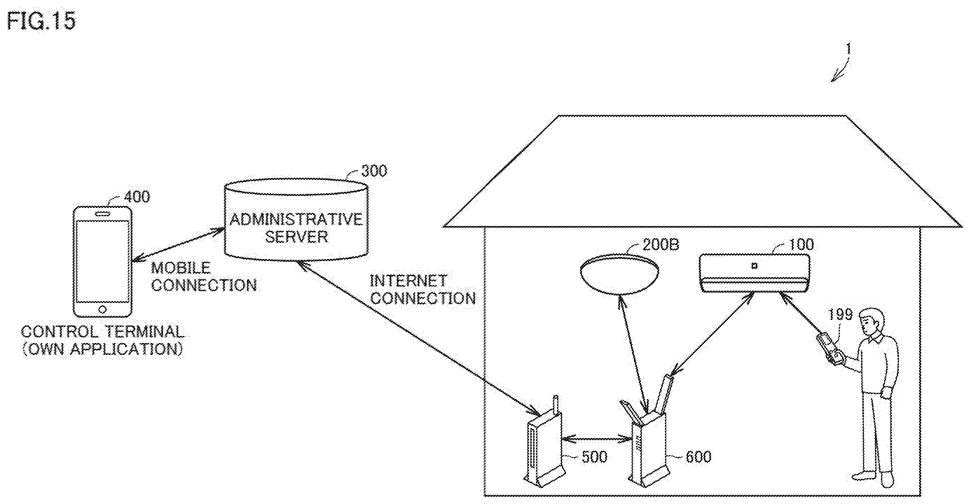

Not surprisingly, an association also may be made between an air conditioner 100 and a light 200C, as shown in FIGS. 14 and 15. In this case, the data acquired by an illuminance sensor and a motion sensor of the light 200C become available for use by the air conditioner 100. For example, in response to the light 200C being turned off, the CPU 210 of the light 200C may send this information to the server 300, and the CPU 310 of the server 300 may cause the air conditioner 100 to start running in sleep mode after a predetermined elapsed time period, via the communication interface 360.

As another example, the air conditioner 100 may include an illuminance sensor, and the system may be adapted so that, in response to the level of ambient light turning low, the air conditioner 100 starts running in sleep mode, and, when the associated device is an air purifier 200, the system may reduce the airflow of the air purifier 200, or lower the brightness of the LED light and display or turn off these lights. When the associated device is a television 200B, the system may be adapted to lower the brightness of the television 200B, or turn down the volume of the television 200B. Alternatively, the system may be adapted to turn up the volume of the television 200B in response to increase of the airflow of the air conditioner 100. When the associated device is a light 200C, the system may be adapted to turn on the light 200C or increase the illuminance in response to the level of ambient light turning low, or to turn off the light 200C or decrease the illuminance in response to the level of ambient light turning up. It is also possible to create an association between all of the air conditioner 100, the air purifier 200, the television 200B, and the light 200C.

### Third Embodiment

The role of each device in the network systems 1 of First and Second Embodiments may be served by other devices, either in part or as a whole. For example, part or all of the roles of the server 300, the air purifier 200, the air conditioner 100, and the smartphone 400 may individually be served by other devices, or part or all of the roles of each device may be shared by a plurality of devices. For example, the air conditioner 100 and the air purifier 200 may directly exchange data without the server 300, and the CPU 110 of the air conditioner 100 or the CPU 210 of the air purifier 200 may serve to determine association conditions, instead of the server 300.

### Review

The foregoing embodiments provide a network system 1 that includes a first air conditioning device 100 (200), a second air conditioning device 200 (100), and a server 300 that controls the second air conditioning device 200 (100) in accordance with information from the first air conditioning device 100 (200).

Preferably, the first air conditioning device 100 has a room-temperature adjusting function. The second air conditioning device 200 has a humidifying function.

Preferably, the server 300 causes the second air conditioning device 200 to perform a humidifying operation in response to the first air conditioning device 100 starting a heating operation.

Preferably, the first air conditioning device 200 has an illuminance sensor 250. The second air conditioning device 100 has a room-temperature adjusting function.

Preferably, the server 300 causes the second air conditioning device 100 to perform a sleep operation in response to the first air conditioning device 200 detecting darkness in a room.

Preferably, the network system 1 further includes a terminal 400. The terminal 400 pairs itself with the first air conditioning device 100 and with the second air conditioning device 200. The server 300, as per an instruction from the terminal 400, creates an association between the first air conditioning device 100 and the second air conditioning device 200 being paired with the terminal 400.

Preferably, the terminal 400 accepts an instruction selecting the first air conditioning device 100 and the second air conditioning device 200 as devices to be associated with each other from among a plurality of paired devices, and sends the selection instruction to the server.

The embodiments disclosed herein are to be considered in all aspects only as illustrative and not restrictive. The scope of the present invention is to be determined by the scope of the appended claims, not by the foregoing descriptions, and the invention is intended to cover all modifications falling within the equivalent meaning and scope of the claims set forth below.

### REFERENCE SIGNS LIST

1: Network system.
100: Air conditioner
110: CPU
120: Memory
130: Display
140: Control
160: Communication interface
170: Speaker
180: Remote control photoreceiver
190: Device drive unit
199: Remote controller
200: Air purifier
200B: Television
200C: Light
210: CPU
220: Memory
230: Display
240: Control
250: Sensor
260: Communication interface
270: Speaker
280: Remote control photoreceiver
290: Device drive unit
300: Server
310: CPU
320: Memory
321: Device data
322: Associated operation data
323: Association data
324: Associated pair data
330: Display
340: Control
360: Communication interface
400: Smartphone
410: CPU
420: Memory
430: Display
440: Control
460: Communication interface
470: Speaker
480: Microphone
500: Modem
600: Router

1. A network system comprising:
a first air conditioning device;
a second air conditioning device; and
a server that controls the second air conditioning device in accordance with information from the first air conditioning device.

2. The network system according to claim 1, wherein the first air conditioning device has a room-temperature adjusting function, and the second air conditioning device has a humidifying function.

3. The network system according to claim 2, wherein the server causes the second air conditioning device to perform a humidifying operation in response to the first air conditioning device starting a heating operation.

4. The network system according to claim 1, wherein the first air conditioning device has an illuminance sensor, and the second air conditioning device has a room-temperature adjusting function.

5. The network system according to claim 4, wherein the server causes the second air conditioning device to perform a sleep operation in response to the first air conditioning device detecting darkness in a room.

6. The network system according to claim 1, wherein:
the network system further comprises a terminal,
the terminal pairs itself with the first air conditioning device and with the second air conditioning device, and
the server, as per an instruction from the terminal, creates an association between the first air conditioning device and the second air conditioning device being paired with the terminal.

7. The network system according to claim 6, wherein the terminal accepts an instruction selecting the first air conditioning device and the second air conditioning device as devices to be associated with each other from among a plurality of paired devices, and sends the selection instruction to the server.
